(19) United States
(12) Patent Application Publication
(10) Pub. No.: US 2026/0323463 A1
(43) Pub. Date: Oct. 15, 2026

(54) METHOD AND APPARATUS FOR SELECTING AN EDGE APPLICATION SERVER FOR A UE WHILE TAKING INTO ACCOUNT MOBILITY OF THE UE

(71) Applicant: TELEFONAKTIEBOLAGET LM ERICSSON (PUBL), Stockholm (SE)

(72) Inventor: Wenliang XU, Shanghai (CN)

(21) Appl. No.: 19/481,380

(22) PCT Filed: May 9, 2024
(86) PCT No.: PCT/IB2024/054538

§ 371 Date: Nov. 4, 2025

(30) Foreign Application Priority Data
May 9, 2023 (WO) PCT/CN2023/092930

(51) Int. Cl. H04W 36/32; H04L 41/5009; H04W 8/00

(52) U.S. Cl. CPC H04W 36/322; H04L 41/5009; H04W 8/005

(57) ABSTRACT

According to an aspect, there is provided a method for execution by an EES (Edge Enabler Server) of an EDN (Edge Data Network). The method involves, during a service continuity procedure involving an AC (Application Client) of a UE (User Equipment), receiving a first message indicating a prediction expiration time. The prediction expiration time is an estimated time that the UE may reach a predicted/expected UE location or an EAS (Edge Application Server) service area at latest. In accordance with an embodiment of the disclosure, the method also involves determining at least one candidate EAS for the AC of the UE based on at least the prediction expiration time, and sending a second message based on the at least one candidate EAS that has been determined. In this way, selection of an EAS can be performed in a suitable way that takes into account mobility of the UE.

### RELATED APPLICATION

This patent application claims priority from PCT provisional patent application no. PCT/CN2023/092930 filed on May 9, 2023, the disclosure of which is incorporated by reference in its entirety.

### FIELD OF THE DISCLOSURE

This disclosure relates to wireless communication systems, and more particularly to edge applications in a wireless communication system.

### BACKGROUND

3GPP (3rd Generation Partnership Project) TS (Technical Standard) 23.558 entitled “Architecture for enabling Edge Applications” version 18.2.0 uploaded 2023 Mar. 31 (hereinafter “TS 23.558”) specifies application layer architecture, procedures and information flows for enabling edge applications over 3GPP networks. It includes architectural considerations for enabling edge applications, application layer architecture fulfilling the architectural considerations, and procedures to enable deployment of edge applications.

Referring to FIG. 1, shown is a block diagram of a communication system 100 for enabling edge applications, in accordance with a known implementation. Such communication system 100 has an architecture that is specified in TS 23.558—see especially clause 6 of TS 23.558. As shown, an EDN (Edge Data Network) 110 is a local data network having at least one EAS (Edge Application Server) 111 and at least one EES (Edge Enabler Server) 112. An ECS (Edge Configuration Server) 150 provides configurations related to the EES 112, including details of the EDN 110 hosting the EES 112. A UE (User Equipment) 120 has at least one AC (Application Client) 121 and an EEC (Edge Enabler Client) 122. The EAS(s) 111, the EES 112 and the ECS 150 can interact with a 3GPP Core Network 130. When SEAL (Service Enabler Architecture Layer) is implemented for a notification management service as shown, the EES 112 and the ECS 150 interact with a SEAL notification management server 140 and the EEC 122 interacts with a SEAL notification management client 123.

EAS and T-EAS (target EAS) discovery procedures are specified in clauses 8.5 and 8.8.3.2 of TS 23.558. An EAS discovery procedure offers EAS discovery service to the EEC 122 of the UE 120, with both subscribe-notify and request-response communication types being supported. The EAS 111 to be used by an AC 121 of the UE 120 can be selected by either the EEC 122 of the UE 120 or the EES 112 of the EDN 110. A T-EAS discovery procedure is used by a consumer, such as the EEC 122, an S-EAS (source EAS) or an S-EES (source EES), to discover a target EAS(s) during service continuity. Note that service continuity supports service continuity planning feature as described in clause 8.8.1.2 of TS 23.558.

### SUMMARY OF THE DISCLOSURE

During the EAS discovery and T-EAS discovery procedures, it is possible to indicate an SCP (Service Continuity Planning) to the EES, and the EES may use an ADAES (Application Data Analytics Enablement Service) in edge load performance analytics in order to offer an EAS (either candidate EAS(s) or a selected EAS) with good service quality to the consumer of the EES. The SCP is based on an estimation of UE behavior regarding mobility and session (i.e. usage of the EAS by the AC of the UE). However, it may be unknown when the UE is expected to move to a new location and start communication with the EAS.

According to an aspect, there is provided a method for execution by an EES (Edge Enabler Server) of an EDN (Edge Data Network). The method involves, during a service continuity procedure involving an AC (Application Client) of a UE (User Equipment), receiving a first message indicating a prediction expiration time. The prediction expiration time is an estimated time that the UE may reach a predicted/expected UE location or an EAS (Edge Application Server) service area at latest. In accordance with an embodiment of the disclosure, the method also involves determining at least one candidate EAS for the AC of the UE based on at least the prediction expiration time, and sending a second message based on the at least one candidate EAS that has been determined. In this way, selection of an EAS can be performed in a suitable way that takes into account mobility of the UE. This can solve or mitigate the problem noted above.

In some implementations, the first message is an EAS discovery request, an EAS discovery subscription request, or an EAS discovery update request. In some implementations, the first message is received from an EEC (Edge Enabler Client) of the UE, a source EAS, or a source EES.

In some implementations, the second message is an EAS discovery notification or an EAS discovery response. In some implementations, the second message indicates the at least one candidate EAS. In some implementations, the second message is sent before expiration of the prediction expiration time. In some implementations, the second message includes prediction information that indicates a prediction confidence level for EAS service status change and prediction validity time for such EAS service status change.

In some implementations, the method also involves receiving edge load analytics from ADAES and/or performance data from OAM (Operations, Administration and Maintenance), and confirming whether the at least one candidate EAS satisfies an expected AC service KPIs or minimum required AC service KPIs. In some implementations, the method also involves receiving prediction request and/or local policy, and using received EAS endpoints from EEC or all registered EAS endpoints in consuming ADAES to monitor EAS service status.

In EAS discovery subscription, an event type of dynamic EAS info change is supported. However, conventional approaches do not support monitoring of EAS info change for a particular EAS, and do not support using analytics service during monitoring and sending a notification report with predicted result for EAS status and schedule. However, some implementations of the present disclosure address these deficiencies of the conventional approaches in the manner summarized above.

According to another aspect, there is provided a non-transitory CRM (Computer Readable Medium) having recorded thereon statements and instructions that, when executed by a processor of an EES of an EDN, configure the processor to implement a method summarized above.

According to another aspect, there is provided an EES of an EDN. The EES has a network interface configured to communicate with other network nodes, and candidate EAS circuitry coupled to the network interface. The EAS circuitry is configured to, during a service continuity procedure involving an AC of a UE, receive over the network interface a first message indicating a prediction expiration time. The prediction expiration time is an estimated time that the UE may reach a predicted/expected UE location or an EAS service area at latest. The EAS circuitry is also configured to determine at least one candidate EAS for the AC of the UE based on at least the prediction expiration time, and send a second message over the network interface based on the at least one candidate EAS that has been determined. In this way, selection of an EAS can be performed in a suitable way that takes into account mobility of the UE. This can help solve or mitigate the problem(s) noted above.

According to another aspect, there is provided a method for execution by an EES of an EDN. The method involves, during a service continuity procedure involving an AC of a UE, determining at least one candidate EAS for the AC of the UE, and sending a message based on the at least one candidate EAS that has been determined. In accordance with an embodiment of the disclosure, the message includes prediction information that indicates a prediction confidence level for EAS service status change and prediction validity time for such EAS service status change. This can help solve or mitigate the problem(s) noted above.

In some implementations, the at least one candidate EAS is determined based on an EEC prediction request and/or local policy.

According to another aspect, there is provided a non-transitory CRM having recorded thereon statements and instructions that, when executed by a processor of an EES of an EDN, configure the processor to implement a method summarized above.

According to another aspect, there is provided an EES of an EDN. The EES has a network interface configured to communicate with other network nodes, and candidate EAS circuitry coupled to the network interface. The EAS circuitry is configured to, during a service continuity procedure involving an AC of a UE, determine at least one candidate EAS for the AC of the UE, and send a message over the network interface based on the at least one candidate EAS that has been determined. In accordance with an embodiment of the disclosure, the message includes prediction information that indicates a prediction confidence level for EAS service status change and prediction validity time for such EAS service status change. This can help solve or mitigate the problem(s) noted above.

In some implementations, the candidate EAS circuitry determines the at least one candidate EAS based on an EEC prediction request and/or local policy.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of a communication system for enabling edge applications, in accordance with a known implementation;

FIG. 2 is a block diagram of another communication system for enabling edge applications, in accordance with an embodiment of the disclosure;

FIGS. 3A and 3B are flowcharts of methods of selecting an EAS for a UE in a manner that takes into account mobility of the UE;

FIG. 4 is a signalling drawing of an EAS Discovery procedure;

FIG. 5 is a signalling drawing of an EAS discovery subscription procedure between the EEC and the EES;

FIG. 6 is a signalling drawing of an EAS discovery notification procedure between the EEC and the EES;

FIG. 7 is a signalling drawing of an EAS discovery subscription update procedure between the EEC and the EES;

FIG. 8 is a signalling drawing of a procedure for fetching T-EAS information;

FIG. 9 is a schematic of an example cellular communications system in which some embodiments of the present disclosure may be implemented;

FIGS. 10A and 10B are block diagrams of a wireless communication system represented as a 5G network architecture in which some embodiments of the present disclosure may be implemented;

FIGS. 11 and 13 are block diagrams of a radio access node according to some embodiments of the present disclosure;

FIG. 12 is a block diagram that illustrates a virtualized embodiment of a radio access node according to some embodiments of the present disclosure;

FIGS. 14 and 15 are block diagrams of a wireless communication device; and

FIG. 16 is a schematic of an example communication system according to some embodiments of the present disclosure.

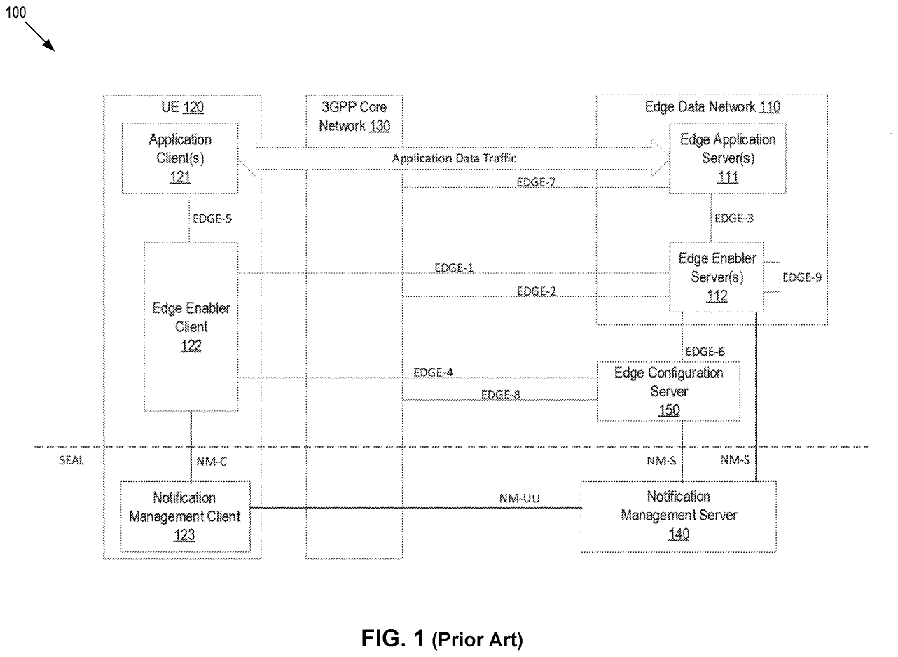

### DETAILED DESCRIPTION OF EMBODIMENTS

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

### INTRODUCTION

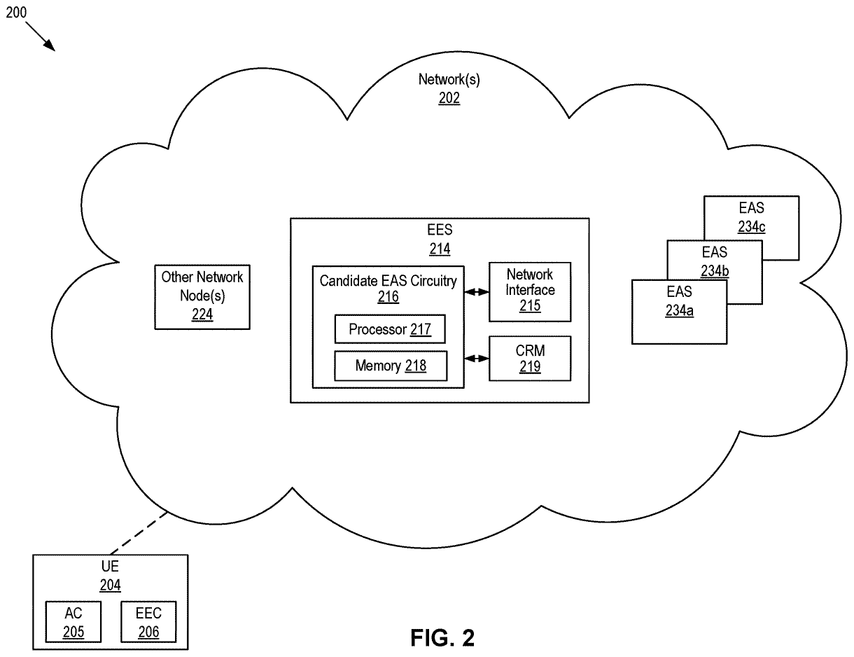

Referring now to FIG. 2, shown is a block diagram of another communication system 200 for enabling edge applications, in accordance with an embodiment of the disclosure. The communication system 200 has an EES 214 operatively coupled to a set of EASs 234a-c via at least one network 202. Note that there may be additional network nodes 224 but such details are not shown for simplicity. The communication system 200 also has a UE 204 coupled to the network 202. Normally there would be numerous communication devices in the communication system 200, but they are not shown for simplicity. The communication system 200 may have other components that are not shown for simplicity.

The EES 214 has a network interface 215 configured to communicate with other nodes of the communication system 200, a CRM 219, and candidate EAS circuitry 216 coupled to the network interface 215 and the CRM 219. In some implementations, the candidate EAS circuitry 226 includes a processor 217 that executes software, which can stem from a memory 128. However, other implementations are possible and are within the scope of this disclosure. The EES 214 can have additional components, but these are not shown for simplicity.

During the EAS discovery and T-EAS discovery procedures, it is possible to indicate an SCP to the EES 214, and the EES 214 may use an ADAES in edge load performance analytics in order to offer an EAS 234a-c (either candidate EAS(s) or a selected EAS) with good service quality to the consumer of the EES 214. The SCP is based on an estimation of UE behavior regarding mobility and session (i.e. usage of the EAS by AC 205 of the UE 204). However, it may be unknown when the UE 204 is expected to move to a new location and start communication with the EAS 234a-c.

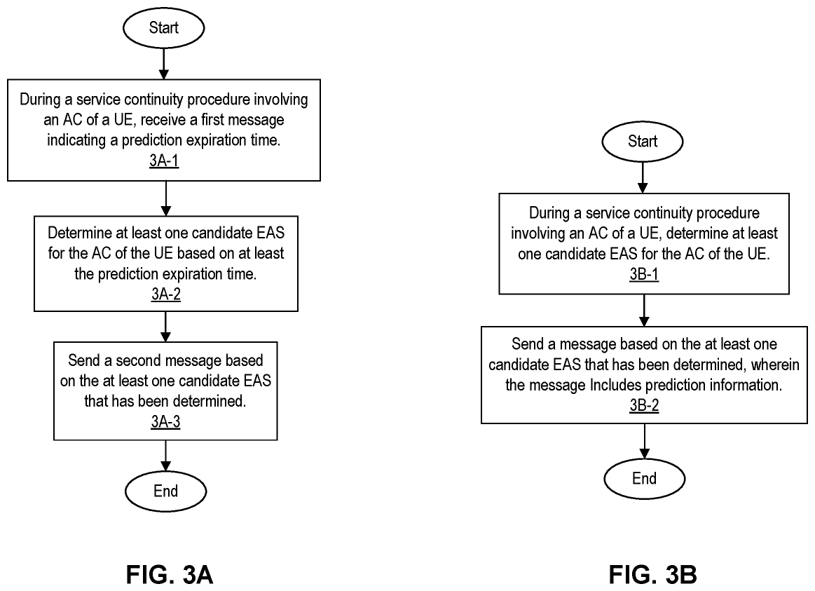

Therefore, the candidate EAS circuitry 216 of the EES 214 operates to implement a method of selecting an EAS 234a-c for the UE 204 in a manner that takes into account mobility of the UE 204. Such operation will be described below with reference to FIGS. 3A and 3B. Although the methods of FIGS. 3A and 3B are described below with reference to the communication system 200 shown in FIG. 2, it is to be understood that the methods of FIGS. 3A and 3B are applicable to other communication systems. In general, the methods of FIGS. 3A and 3B are applicable to any appropriately configured communication system.

Referring first to FIG. 3A, at step 3A-1, during a service continuity procedure involving the AC 205 of the UE 204, the EES 214 receives a first message indicating a prediction expiration time. The prediction expiration time is an estimated time that the UE 204 may reach a predicted/expected UE location or an EAS service area at latest. This information element can be used by EES 214 as analytics input (e.g. when consuming ADAES service).

In accordance with an embodiment of the disclosure, at step 3A-2 the EES 214 determines at least one candidate EAS 234a-c for the AC 205 of the UE 204 based on at least the prediction expiration time, and then at step 3A-3 the EES 214 sends a second message based on the at least one candidate EAS 234a-c that has been determined. For example, the EES 214 might select the first EAS 234a (instead of the other EASs 234b-c) based on the prediction expiration time. In this way, selection of the EAS 234a can be performed in a manner that takes into account mobility of the UE 204. This can solve or mitigate the problem noted above.

There are many possibilities for the first message. In some implementations, the first message is an EAS discovery request. In other implementations, the first message is an EAS discovery subscription request. In other implementations, the first message is an EAS discovery update request. In some implementations, the first message is received from the EEC 206 of the UE 204. In other implementations, the first message is received from some other network node 224, for example a source EAS and/or a source EES. Other implementations are possible. Other implementations are possible.

The entity (e.g. EEC, EAS) supplying the “prediction expiration time” is assumed to have certain prediction information available, for example based on observed behavior. For instance, if Alice takes Metro line 2 every working day, and starts an application session approximately from 8:00 am to 8:40 am from station 1 to station 8, then this UE behavior can be recorded by a 3GPP system and analyzed further to provide better service. For initial EAS discovery, the EEC 206 can trigger the EAS discovery procedure at 7:45 am and include “UE location” IE set to “Metro line 2, station 1” and “prediction expiration time” IE set to 15 minutes. For subsequent EAS discovery during service continuity, the EEC 206 or EAS or EES can trigger T-EAS discovery procedure at 8:30 am and include “UE location” IE set to “Metro line 2, station 8” and “prediction expiration time” IE set to 10 minutes. To supply “UE Location” and “prediction expiration time”, EEC in the UE can collect UE mobility and communication information every day and perform UE behavior prediction. This is internal behavior in UE. The EAS, EES or EEC can also utilize 3GPP core network API (offered by NEF/NWDAF) for UE mobility and communication analytics, which is specified in clauses 6.7.2 and 6.7.3 of 3GPP TS 23.288 entitled “Architecture enhancements for 5G System (5GS) to support network data analytics services” version 18.1.0 uploaded 2023 Mar. 31 (hereinafter “TS 23.288”). The determination at step 3A-2 is performed by the EES 214 based on analytics from ADAES for edge performance so that the EES 214 knows which EAS(s) are best to serve the AC at the given time.

There are many possibilities for the second message. In some implementations, the second message is an EAS discovery notification. In other implementations, the second message is an EAS discovery response. In some implementations, the second message indicates the at least one candidate EAS 234a-c. In some implementations, the second message is sent before expiration of the prediction expiration time. In some implementations, the second message includes prediction information that indicates a prediction confidence level (e.g. in percentage or “high/medium/low”) for EAS service status (e.g. EAS schedule, EAS status) change and prediction validity time for such EAS service status change. Other implementations are possible.

In some implementations, the EES 214 receives edge load analytics from ADAES and/or performance data from OAM, and confirms whether the at least one candidate EAS 234a-c satisfies an expected AC service KPIs or minimum required AC service KPIs. In some implementations, the the EES 214 receives prediction request and/or local policy, and the EES 214 uses received EAS endpoints from EEC 206 or all registered EAS endpoints in consuming ADAES to monitor EAS service status.

In EAS discovery subscription, an event type of dynamic EAS info change is supported. However, conventional approaches do not support monitoring of EAS info change for a particular EAS, and do not support using analytics service during monitoring and sending a notification report with predicted result for EAS status and schedule. However, some implementations of the present disclosure address these deficiencies of the conventional approaches in the manner described above.

Referring now to FIG. 3B, at step 3B-1, during a service continuity procedure involving the AC 205 of the UE 204, the EES 214 determines at least one candidate EAS 234a-c for the AC 205 of the UE 204, and at step 3B-1 the EES 214 sends a message based on the at least one candidate EAS 234a-c that has been determined. In accordance with an embodiment of the disclosure, the message includes prediction information that indicates a prediction confidence level for EAS service status change and prediction validity time for such EAS service status change.

There are many ways that the at least one candidate EAS 234a-c can be determined at step 3B-1. In some implementations, the determination is based on an EEC prediction request and/or local policy. Thus, for some implementations, the determination might not rely on receiving any prediction expiration time as in FIG. 3A. In other implementations, the determination is a function of a combination of prediction expiration time, EEC prediction request and/or local policy. Other implementations are possible.

There are many possibilities for the network 202. In some implementations, the network 202 includes a 5G (Fifth Generation) network. Example details of a 5G network are provided later. However, other implementations for the network 202 are possible other than 5G.

According to another embodiment of the disclosure, there is provided a non-transitory CRM having recorded thereon statements and instructions that, when executed by the processor 217 of the EES 214, implement a method as described herein. The non-transitory computer readable medium can be the memory 218 and/or the CRM 219 of the EES 214 shown in FIG. 2, or some other non-transitory CRM. Examples of a non-transitory CRM include memory, an SSD (Solid State Drive), a hard disk drive, a CD (Compact Disc), a DVD (Digital Video Disc), a BD (Blu-ray Disc), a memory stick, etc. Other non-transitory CRMs are also possible.

The illustrated examples described herein focus on software implementations. However, other implementations are possible and are within the scope of this disclosure. It is noted that other implementations can include additional or alternative hardware components, such as any appropriately configured FPGA (Field-Programmable Gate Array), ASIC (Application-Specific Integrated Circuit), and/or microcontroller, for example. Thus, the candidate EAS circuitry 216 of the EES 214 of the client network node 214 can instead be implemented with any suitable combination of hardware, software and/or firmware.

Further example details are provided in the following sections. It is to be understood that the following sections are very specific and are provided merely for exemplary purposes, such that other implementations are possible and within the scope of the disclosure.

### EXAMPLE IMPLEMENTATION DETAILS

Non-limiting examples are provided below of how certain aspects of the present embodiments could be implemented within the framework of one or more communication standards. However, the present embodiments could also be implemented in other suitable manners, both in the 3GPP Specification and in other specifications or standards.

During EAS discovery or T-EAS discovery, the EES 214 may utilize ADAES service to have analytics for edge load in the discovered EAS(s). The edge load performance analytics from ADAES can be either statistics or predictions. In conventional implementations, it may not be possible for EES to know when the analytics prediction should be computed. In addition, for EAS dynamic info change in EAS discovery subscription, it may not be supported to give a concreate EAS instance endpoint and utilize analytics.

As described herein, the present embodiments can allow for several improvements:
Allow consumer (e.g. EEC, EAS, or EES) to supply prediction expiration time in the T-EAS discovery request in service continuity procedure so that producer EES can offer more appropriate candidate EAS(s) to the consumer considering the prediction expiration time.
Allow the EEC 206 to supply prediction expiration time in initial EAS discovery request to EES so that the EES 214 can offer more appropriate candidate EAS(s) to the EEC 206 considering the prediction expiration time.
Similarly, in EAS discovery subscribe-notify procedure, the EEC 206 can supply prediction expiration time to the EES 214 so that the EES 214 can offer more appropriate candidate EAS(s) to the EEC 206 considering the predicted expiration time.
Prediction without considering when UE is expected to arrive at target EAS service area can lead to wrong decision in EES to offer candidate T-EAS(s) or select T-EAS in service continuity or to offer candidate EAS(s) or select T-EAS in initial EAS discovery.
In addition, the EAS status monitoring for EAS instance(s) are added in dynamic EAS info change subscription and prediction information is added in report.

### Request-Response Model

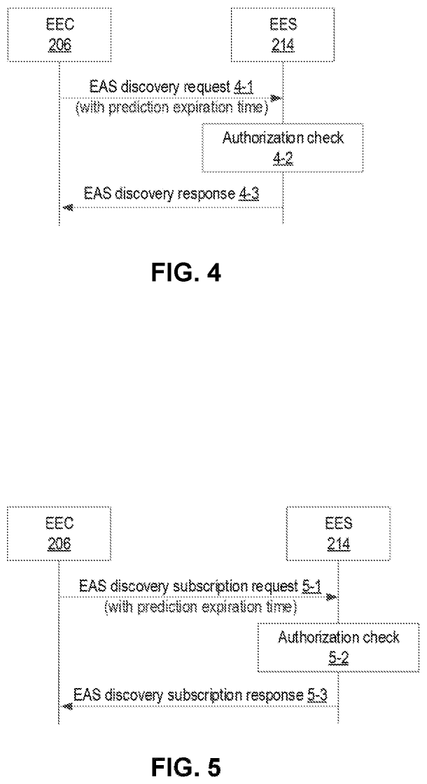

Referring now to FIG. 4, shown is a signalling drawing of an EAS Discovery procedure. Pre-conditions:
1. The EEC 206 has received information (e.g. URI, IP address) related to the EES 214;
2. The EEC 206 has received appropriate security credentials authorizing it to communicate with the EES 214 as specified in clause 8.11 of TS 23.558; and
3. The EES 214 is configured with ECSP's policy for EAS discovery.
NOTE 1: Details of ECSP's policy are out of scope.

At step 4-1, the EEC 206 sends an EAS discovery request to the EES 214. The EAS discovery request includes the requestor identifier [EECID] along with the security credentials and may include EAS discovery filters and may also include UE location to retrieve information about particular EAS(s) or a category of EASs, e.g. gaming applications, or Edge Applications Server(s) available in certain service areas, e.g. available on a UE's predicted or expected route. The request may include an EAS selection request indicator or UE type or prediction expiration time.

At step 4-2, upon receiving the request from the EEC 206, the EES 214 checks if the EEC 206 is authorized to discover the requested EAS(s). The authorization check may apply to an individual EAS, a category of EASs or to the EDN, i.e. to all the EASs. If UE's location information is not already available, the EES 214 obtains the UE location by utilizing the capabilities of the 3GPP core network as specified in clause 8.10.3 of TS 23.558. If EAS discovery filters are provided by the EEC 206, the EES 214 identifies the EAS(s) based on the provided EAS discovery filters and the UE location.

When the bundle EAS information is provided, then;
If bundle EAS information includes EAS bundle identifier, the EES 214 identifies all or part of the EAS(s) associated the same EAS bundle identifier.
If bundle EAS information includes a list of EASIDs, the EES 214 identifies the EASs which are all or part of the EAS bundle.

If the EEC 206 indicates that service continuity support is required, the EES 214 shall take the indication which ACR scenarios are supported by the AC and the EEC 206 and which of these are preferred by the AC into consideration. The EES 214 may select one EAS and determine whether to perform application traffic influence for this AC based on AC's service KPI or EAS's service KPI in desired response time, when the EAS does not perform traffic influence in advance.

When EAS discovery filters are not provided, then:
if available, the EES 214 identifies the EAS(s) based on the UE-specific service information at the EES 214 and the UE location;
EES identifies the EAS(s) by applying the ECSP policy (e.g. based only on the UE location);
NOTE 2: Details of the UE-specific service information and how it is available at the EES 214 is out of scope.
NOTE 3: Both steps are evaluated prior to sending a response.

Upon receiving the request from the EEC 206, if the EEC 206 does not indicate EAS Instantiation Triggering Suppress in the EAS Discovery request, the EES 214 may trigger the EAS management system to instantiate the EAS that matches with EAS discovery filter IEs (e.g. ACID) as in clause 8.12 of TS 23.558.

Otherwise, upon receiving the request from the EEC 206, if the EEC 206 indicates EAS Instantiation Triggering Suppress in the EAS Discovery request and the EES 214 supports such capability, the EES 214 may determine Instantiable EAS Information for EAS(s) that are instantiable but not yet instantiated and match the EAS discovery filter IEs. Instantiable EAS Information is provided in the EAS Discovery response and includes the EASID(s) and, for each EASID, the status indicating whether the EAS is instantiated or instantiable but not yet instantiated.

If the EEC 206 provides in the EAS discovery request the EAS selection request indicator, the EES 214 selects EAS satisfying the EAS discovery filter or based on other information (e.g. ECSP policy) as described above (if no EAS discovery filter received), and then provides the selected EAS information to the EEC 206 in the discovered EAS list of EAS discovery response.
NOTE 4: Without EAS selection request indication, the EES 214 handling is as per R17 procedure.

At step 4-3, if the processing of the request was successful, the EES 214 sends an EAS discovery response to the EEC 206, which includes information about the discovered EASs and Instantiable EAS Information. For discovered EASs, this includes endpoint information. Depending on the EAS discovery filters received in the EAS discovery request, the response may include additional information regarding matched capabilities, e.g. service permissions levels, KPIs, AC locations(s) that the EASs can support, ACR scenarios supported by the EAS, etc. The EAS discovery response may contain a list of EASs and Instantiable EAS Information. This list may be based on EAS discovery filters containing a Geographical or Topological Service Area, e.g. a route, included in the EAS discovery request by the EEC 206.

If the EES 214 is unable to determine the EAS information using the inputs in the EAS discovery request, UE-specific service information at the EES 214 or the ECSP policy, the EES 214 shall reject the EAS discovery request and respond with an appropriate failure cause.

If the EEC is not registered with the EES 214, and ECSP policy requires the EEC 206 to perform EEC registration prior to EAS discovery, the EES 214 shall include an appropriate failure cause in the EAS discovery response indicating that EEC registration is required.

If the UE location and predicted/expected UE locations, provided in the EAS discovery request, are outside the Geographical or Topological Service Area of an EAS, then the EES 214 shall not include that EAS in the discovery response. The discovery response may include EAS(s) that cannot serve the UE at its current location if a predicted/expected UE location was provided in the EAS discovery request.

Upon receiving the EAS discovery response, if the EEC 206 selects an EAS which is instantiated (i.e., an EAS profile was provided), the EEC 206 uses the endpoint information for routing of the outgoing application data traffic to EAS(s), as needed, and may provide necessary notifications to the AC(s). The EEC 206 may use the border or overlap between EAS Geographical Service Areas for service continuity purposes. The EEC 206 may cache the EAS information (e.g. EAS endpoint) for subsequent use and avoid the need to repeat step 4-1. If the Lifetime IE is included in the response, the EEC 206 may cache the EAS information only for the duration specified by the Lifetime IE.

Upon receiving the EAS discovery response, if the EEC 206 selects an EAS which is not instantiated (i.e. an EAS profile is not provided), the EEC 206 sends the EAS information provisioning request indicating the selected EASID as in clause 8.15 of TS 23.558.
NOTE 5: Within the duration specified by the Lifetime IE, the cached EAS Profile can be updated (e.g. according to notifications from the EES 214 for changes of EAS information due to EAS status change) or the cached EAS Profile can be invalidated due to new EAS information discovery (e.g. due to UE mobility). The EEC 206 can update or invalidate the cached EAS information (e.g. on PDU Session Release or Modification Command).
NOTE 6: The AC can cache the EAS information (e.g. EAS endpoint) for subsequent use. In the case of the cached information needing to be updated or invalidated, the mechanisms for the EEC 206 to notify the AC is up to implementation.
NOTE 7: The EEC 206 can use the EAS information provided by the discovery procedure to perform service continuity planning, for example when ultra-low latency ACR is required.

If the EAS discovery request fails, the EEC 206 may resend the EAS discovery request, taking into account the received failure cause. If the failure cause indicated that EEC registration is required, the EEC 206 shall perform an EEC registration before resending the EAS discovery request.
NOTE 8: As long as a proper EAS (e.g. considering expected AC service KPIs included in EAS discovery request) is discovered and selected by the EES 214, EEC of a constraint UE can stop sending EAS discovery to rest candidate EES(s), and provide the selected EAS information to AC.

### Subscribe

Referring now to FIG. 5, shown is a signalling drawing of an EAS discovery subscription procedure between the EEC 206 and the EES 214. This subscription enables EES to inform EEC of various EAS discovery related events of interest to EEC (e.g. EAS discovery notification and EAS dynamic information). Pre-conditions:
1. The EEC 206 has received information (e.g. URI, IP address) related to the EES 214;
2. The EEC 206 has received appropriate security credentials authorizing it to communicate with the EES 214 as specified in clause 8.11 of TS 23.558;
3. The EES 214 is configured with ECSP's policy for EAS discovery; and
4. The EEC 206 has optionally acquired a Notification Target Address to be used in its subscriptions to notifications.
NOTE 1: Details of ECSP's policy are out of scope.
NOTE 2: How the EEC 206 acquires the notification target address or a notification channel URI to receive the notifications is up to implementation. The notification target address can terminate at the EEC 206 (e.g. in an IoT device) if the deployment supports EEC reachability, or it can terminate at a push notification service. Details of the push notification service are up to implementation.

At step 5-1, the EEC 206 sends an EAS discovery subscription request to the EES 214. The EAS discovery subscription request includes the EECID along with the security credentials, Event ID, and may include EAS discovery filters and EAS dynamic information filters to subscribe to information about particular EAS(s) or a category of EASs (e.g. gaming applications) or dynamic information about EAS(s). For EAS availability event, the request may include prediction expiration time. For EAS dynamic information change event, the request may include a prediction request.

At step 5-2, upon receiving the request from the EEC 206, the EES 214 checks if the EEC 206 is authorized to subscribe for information of the requested EAS(s). The authorization check may apply to an individual EAS, a category of EASs or to the EDN, i.e. to all the EASs. The EES 214 may utilize the capabilities (e.g. UE location) of the 3GPP core network as specified in clause 8.10.3 of TS 23.558. If the request is authorized, the EES 214 creates and stores the subscription for EAS discovery.

At step 5-3, if the processing of the request was successful, the EES 214 sends an EAS discovery subscription response to the EEC 206, which includes the subscription identifier and may include the expiration time, indicating when the subscription will automatically expire. To maintain the subscription, the EEC 206 shall send an EAS discovery subscription update request prior to the expiration time. If an EAS discovery subscription update request is not received prior to the expiration time, the EES 214 shall treat the EEC 206 as implicitly unsubscribed.

If the request includes prediction expiration time, the EES 214 should notify the EEC 206 before prediction time expires.

In the case of subscription to an EAS availability change event, if there is no instantiated EAS that matches the requested EAS discovery filters and such EAS is instantiable based on the pre-configured information about instantiable EASs, the request is treated as successful. If the EEC 206 indicates EAS Instantiation Triggering in the EAS discovery subscription request, the EES 214 may trigger dynamic instantiation of the EAS as specified in the clause 8.12 of TS 23.558; otherwise, the EES 214 does not trigger the EAS instantiation.

In the case of subscription to an EAS dynamic information change event, if the EES 214 is unable to determine the instantiated EAS information using the inputs in the EAS discovery subscription request, UE-specific service information at the EES 214 or the ECSP policy, the EES 214 shall reject the EAS discovery subscription request and respond with an appropriate failure cause.

If the EEC 206 is not registered with the EES 214, and ECSP policy requires the EEC 206 to perform EEC registration prior to EAS discovery, the EES 214 shall include an appropriate failure cause in the EAS discovery response indicating that EEC registration is required.

If the EAS discovery subscription request fails, the EEC 206 may resend the EAS discovery subscription request again, taking into account the received failure cause. If the failure cause indicated that EEC registration is required, the EEC 206 shall perform an EEC registration before resending the EAS discovery subscription request.

### Notify

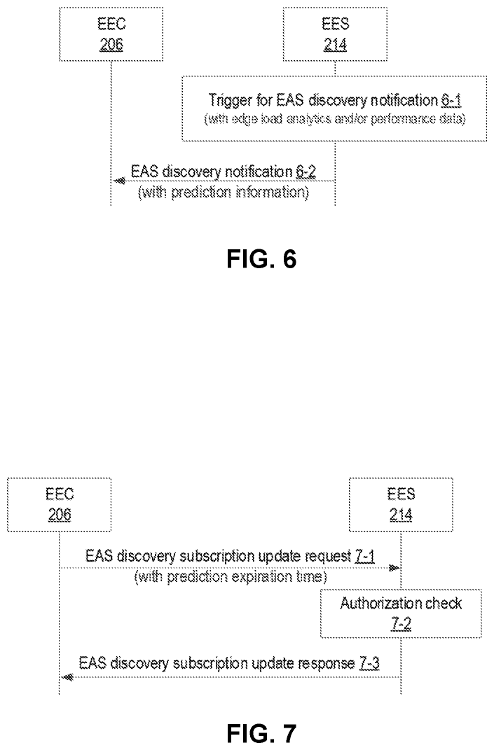

Referring now to FIG. 6, shown is a signalling drawing of an EAS discovery notification procedure between the EEC 206 and the EES 214. Pre-conditions:
1. The EEC 206 has subscribed with the EES 214 for the EAS discovery information as specified in clause 8.5.2.3.2 of TS 23.558.

At step 6-1, an event occurs at the EES 214 that satisfies trigger conditions for notifying (e.g. to provide EAS discovery information or EAS dynamic information) a subscribed EEC. If UE's location information is not already available, the EES 214 obtains the UE location by utilizing the capabilities of the 3GPP core network as specified in clause 8.10.2 of TS 23.558. If EAS discovery filters were provided by the EEC 206 during subscription creation, the EES 214 identifies the EAS(s) based on the provided EAS discovery filters and the UE location.

For EAS availability event, the EES 214 may also collect edge load analytics from ADAES (as specified in clause 8.8.2 of TS 23.436 entitled “Functional architecture and information flows for Application Data Analytics Enablement Service” version 1.0.0 uploaded 2023 Mar. 15, hereinafter “TS 23.436”) or performance data from OAM to find whether the EAS(s) satisfies the Expected AC service KPIs or the Minimum required AC Service KPIs.

For EAS dynamic information change event, the EES 214, considering EEC prediction request and/or local policy, may use received EAS endpoints from EEC or all registered EAS endpoints in consuming ADAES services (e.g. as specified in clause 8.8.2 of TS 23.436) to monitor EAS service status like EAS status and EAS schedule.

When the bundle EAS information is provided, then:
If EAS bundle identifier was provided, the EES 214 identifies all or part of the EAS(s) associated with the same EAS bundle identifier.
If a list of EASIDs is provided, the EES 214 identifies the EASs which are all or part of the EAS bundle.
If the EEC 206 indicates that service continuity support is required, the EES 214 shall take the indication which ACR scenarios are supported by the AC and the EEC 206 and which of these are preferred by the AC into consideration.

If EAS discovery filters were not provided, then:
if available, the EES 214 identifies the EAS(s) based on the UE-specific service information at the EES 214 and the UE location;
EES identifies the EAS(s) by applying the ECSP policy (e.g. based only on the UE location);
NOTE 1: Details of the UE-specific service information and how it is available at the EES 214 is out of scope.
NOTE 2: Both steps are evaluated prior to sending a response.

If the UE is located outside the Geographical or Topological Service Area of an EAS, then the EES 214 shall not include this EAS in the EAS discovery notification.

At step 6-2, the EES 214 sends an EAS discovery notification to the EEC 206 with the EAS information determined in step 6-1.

### Subscription Update

Referring now to FIG. 7, shown is a signalling drawing of an EAS discovery subscription update procedure between the EEC 206 and the EES 214. Pre-conditions:
1. The EEC 206 has subscribed with the EES 214 for the EAS discovery information as specified in clause 8.5.2.3.2 of TS 23.558.

At step 7-1, the EEC 206 sends an EAS discovery subscription update request to the EES 214. The EAS discovery subscription update request includes the security credentials and the subscription identifier. It may also include EAS discovery filters, EAS dynamic information filters, prediction expiration time and/or proposed expiration time for the updated subscription.

At step 7-2, upon receiving the request from the EEC 206, the EES 214 checks if the EEC 206 is authorized to update the subscription information. The EES 214 may utilize the capabilities (e.g. UE location) of the 3GPP core network as specified in clause 8.10.3 of TS 23.558. If the request is authorized, the EES 214 updated the stored subscription for EAS discovery.

At step 7-3, the EES 214 sends an EAS discovery subscription update response to the EEC 206, which may include the expiration time, indicating when the updated subscription will automatically expire. To maintain the subscription, the EEC 206 shall send an EAS discovery subscription update request prior to the expiration time. If an EAS discovery subscription update request is not received prior to the expiration time, the EES 214 shall treat the EEC 206 as implicitly unsubscribed.

### EAS Discovery Request

Table 1 describes information elements for the EAS discovery request. Table 2 provides further detail about the EAS Discovery Filter information element.

TABLE 1
EAS discovery request

| Information element | Status | Description |
|---|---|---|
| Requestor identifier | M | The ID of the requestor (e.g. EECID) |
| UE Identifier | O | The identifier of the UE (i.e. GPSI or identity token) |
| Security credentials | M | Security credentials resulting from a successful |
| | | authorization for the edge computing service. |
| EAS discovery filters | O | Set of characteristics to determine required EASs, as |
| | | detailed in Table 2. |
| UE location | O | The location information of the UE. The UE location is |
| | | described in clause 7.3.2 of TS 23.558. |
| Serving MNO information | O | The serving MNO information (e.g. MNO name, PLMN ID) |
| (NOTE 2) | | which is serving the subscriber. |
| Target DNAI (NOTE 1) | O | Target DNAI information which can be associated with |
| | | potential T-EAS(s) |
| EEC Service Continuity Support | O | Indicates if the EEC supports service continuity or not. The |
| | | IE also indicates which ACR scenarios are supported by |
| | | the EEC or, if this message is sent by the EEC to discover |
| | | a T-EAS, which ACR scenario(s) are intended to be used |
| | | for the ACR. |
| EES Service Continuity Support | O | The IE indicates if the S-EES supports service continuity or |
| (NOTE 1) | | not. The IE also indicates which ACR scenarios are |
| | | supported by the S-EES or, if the EAS discovery is used |
| | | for an S-EES executed ACR according to clause 8.8.2.5 of |
| | | TS 23.558, which ACR scenario is to be used for the ACR. |
| EAS Service Continuity Support | O | The IE indicates if the S-EAS supports service continuity or |
| (NOTE 1) | | not. The IE also indicates which ACR scenarios are |
| | | supported by the S-EAS or, if the EAS discovery is used |
| | | for an S-EAS decided ACR according to clause 8.8.2.4 of |
| | | TS 23.558, which ACR scenario is to be used for the ACR. |
| EAS Instantiation Triggering | O | Indicates to the EES that EAS instantiation triggering |
| Suppress | | should not be performed for the current request. |
| EAS selection request indicator | O | Indicates the request for EAS selection support from the |
| | | EES (e.g., for constrained device). |
| Prediction expiration time | O | The estimated time the UE may reach the |
| | | Predicted/Expected UE location or EAS service area at the |
| | | latest. This IE is used by EES as analytics input (e.g. when |
| | | consuming ADAES service). |

NOTE 1:
This IE shall not be included when the request originates from the EEC.
NOTE 2:
This IE shall be included if edge node sharing is used.

TABLE 2
EAS discovery filters

| Information element | Status | Description |
|---|---|---|
| List of AC characteristics | O | Describes the ACs for which a matching EAS is needed. |
| (NOTE 1) | | |
| > AC profile (NOTE 2) | M | AC profile containing parameters used to determine |
| | | matching EAS. AC profiles are further described in |
| | | Table 8.2.2-1. |
| List of EAS characteristics | O | Describes the characteristic of required EASs. |
| (NOTE 1, NOTE 3) | | |
| > EASID | O | Identifier of the required EAS. |
| > Bundle ID or list of EASID | O | A list of EASIDs or a bundle ID as described in clause |
| | | 7.2.10 of TS 23.558. |
| > EAS provider identifier | O | Identifier of the required EAS provider |
| > EAS type | O | The category or type of required EAS (e.g. V2X) |
| > EAS schedule | O | Required availability schedule of the EAS (e.g. time |
| | | windows) |
| > EAS Geographical Service | O | Location(s) (e.g. geographical area, route) where the EAS |
| Area | | service should be available. |
| > EAS Topological Service Area | O | Topological area (e.g. cell ID, TAI) for which the EAS |
| | | service should be available. See possible formats in |
| | | Table 8.2.7-1. |
| > Service continuity support | O | Indicates if the service continuity support is required or not. |
| > Service permission level | O | Required level of service permissions e.g. trial, gold-class |
| > Service feature(s) | O | Required service features e.g. single vs. multi-player |
| | | gaming service |

NOTE 1:
Either “List of AC characteristics” or “List of EAS characteristics” shall be present.
NOTE 2:
“Preferred ECSP list” IE shall not be present.
NOTE 3:
The “List of EAS characteristics” IE must include at least one optional IE, if used as an EAS discovery filter.

### EAS Discovery Subscription Request

Table 3 describes the information elements for EAS discovery subscription request from the EEC 206 to the EES 214.

TABLE 3
EAS discovery subscription request

| Information element | Status | Description |
|---|---|---|
| EECID | M | Unique identifier of the EEC. |
| UE Identifier | O | The identifier of the UE (i.e. GPSI or identity token) |
| Event ID | M | Event ID: |
| | | EAS availability change |
| | | EAS dynamic information change |
| Security credentials | M | Security credentials resulting from a successful |
| | | authorization for the edge computing service. |
| Notification Target Address | O | The Notification target address (e.g. URL) where the |
| | | notifications destined for the EEC should be sent to. |
| EAS discovery filters | O | Set of characteristics to determine matching EASs (as |
| | | detailed in Table 2). |
| | | Applicable for “EAS availability change” event |
| EAS dynamic information filters | O | List of dynamic information changes (as detailed in |
| | | Table 4) about EAS, the EEC is interested in. |
| | | Applicable for “EAS dynamic information change” event |
| EEC Service Continuity Support | O | Indicates if the EEC supports service continuity or not. The |
| | | IE also indicates which ACR scenarios are supported by |
| | | the EEC. |
| Proposed expiration time | O | Proposed expiration time for the subscription |
| EAS Instantiation Triggering | O | Indicates to the EES that EAS instantiation triggering may |
| Indication | | be performed for the current request if needed. |
| Prediction expiration time | O | The estimated time the UE may reach the |
| | | Predicted/Expected UE location or EAS service area at the |
| | | latest. This IE is used by EES as analytics input (e.g. when |
| | | consuming ADAES service). |
| | | Applicable for “EAS availability change” event. |
| Prediction request | | Indicates to the EES that the EAS dynamic information |
| | | change report may include prediction information. |
| | | Applicable for “EAS dynamic information change” event. |

Editor's note: Alignment of “EAS Instantiation Triggering Indication” IE with the EAS discovery request procedure is FFS.

TABLE 4
EAS dynamic information filters

| Information element | Status | Description |
|---|---|---|
| List of dynamic information filters | M | List of EAS dynamic information required by the EEC per |
| | | EAS. |
| > EASID | M | Identifier of the EAS |
| > ACIDs | O | Flag to notify change in list of ACIDs served by the EAS |
| > EAS Description | O | Flag to notify change in description of the EAS. |
| > EAS Endpoint | O | Flag to notify change in EAS endpoint. It may also include |
| | | one or more EAS endpoints to be monitored by the EES. If |
| | | no EAS endpoint is provided, all EASs registered in the |
| | | EES will be monitored. |
| > EAS Features | O | Flag to notify any change in features provided by the EAS |
| > EAS Schedule | O | Flag to notify change in availability schedule of the EAS |
| | | (e.g. time windows) |
| > EAS Service Area | O | Flag to notify change in change in geographical service |
| | | area that the EAS serves |
| > EAS Service KPIs | O | Flag to notify change in characteristics of the EAS. |
| > EAS Status | O | Flag to notify change in the status of the EAS (e.g. |
| | | enabled, disabled, etc.) |
| > Service continuity support | O | Flag to notify change in EAS support for service continuity. |

### EAS Discovery Notification

Table 5 describes the information elements for EAS discovery notification from the EES 214 to the EEC 206.

TABLE 5
EAS discovery notification

| Information element | Status | Description |
|---|---|---|
| Subscription ID | M | Subscription identifier corresponding to the subscription |
| | | stored in the EES for the request |
| Event ID | M | Either EAS availability change or EAS dynamic information |
| | | change |
| EAS list | O | List of discovered EAS profiles. Each element includes the |
| | | information described below. |
| > EAS profile | M | Profile of the EAS. Each element is described in |
| | | clause 8.2.4 of TS 23.558 |
| > Lifetime | O | Time interval or duration during which the information |
| | | elements in the EAS profile is valid and supposed to be |
| | | cached in the EEC (e.g. time-to-live value for an EAS |
| | | Endpoint) |
| > Prediction information | O | Indicates the prediction confidence level (e.g. in |
| | | percentage or “high/medium/low”) for EAS service status |
| | | (e.g. EAS schedule, EAS status) change and prediction |
| | | validity time for such a change. |
| Instantiable EAS information | O | The EAS instantiation status per EASID (e.g. instantiated, |
| | | instantiable but not be instantiated yet) |
| > Instantiation criteria | O | The criteria upon which EAS can be instantiated (e.g. |
| (see NOTE) | | based on specific date and time). |

NOTE:
“Instantiation criteria” IE shall be present only when the value of “Instantiable EAS information” IE is “instantiable but not be instantiated yet”.

### EAS Discovery Subscription Update Request

Table 6 describes the information elements for EAS discovery subscription update request from the EEC 206 to the EES 214.

TABLE 6
EAS discovery subscription update request

| Information element | Status | Description |
|---|---|---|
| Subscription ID | M | Subscription identifier corresponding to the subscription to |
| | | be updated |
| Security credentials | M | Security credentials resulting from a successful |
| | | authorization for the edge computing service. |
| Proposed expiration time | O | Proposed expiration time for the subscription |
| EAS discovery filters | O | Set of characteristics to determine required EASs, as |
| | | detailed in Table 2. |
| EAS dynamic information filters | O | List of dynamic information about EAS, the EEC is |
| | | interested in, as detailed in Table 4. |
| EEC Service Continuity Support | O | Indicates if the EEC supports service continuity or not. The |
| | | IE also indicates which ACR scenarios are supported by |
| | | the EEC. |
| Prediction expiration time | O | The estimated time the UE may reach the |
| | | Predicted/Expected UE location or EAS service area at the |
| | | latest. This IE is used by EES as analytics input (e.g. when |
| | | consuming ADAES service). |

### Discover T-EAS

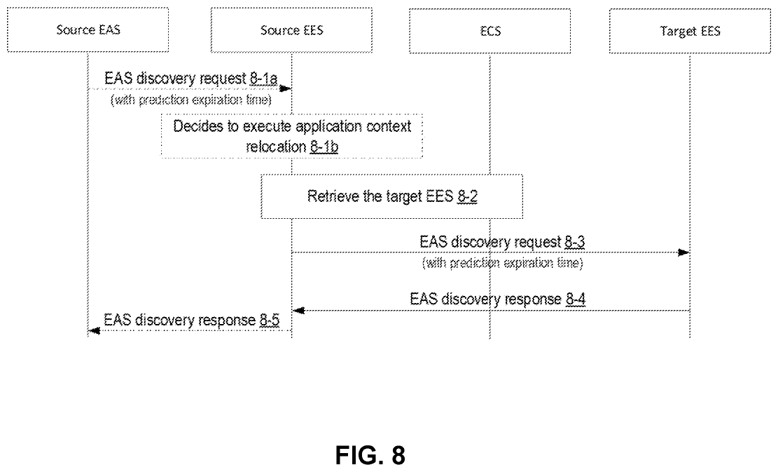

Referring now to FIG. 8, shown is a signalling drawing of a procedure for fetching T-EAS information. This procedure may be utilized by a S-EAS, which undertakes the transfer of application context information to a T-EAS directly, or can be invoked by the S-EES itself on deciding to execute ACR. Pre-conditions:
1. Information related to the EES is available with the S-EAS, if the procedure is triggered by the S-EAS.

The S-EAS sends the EAS discovery request to the S-EES at step 8-1a, or the S-EES decides to execute the ACR at step 8-1b. The EAS discovery request from the S-EAS includes the requestor identifier [EASID] along with the security credentials and includes EAS discovery filter matching its EAS profile. If target DNAI is available at the S-EAS via User Plane Path change event, the S-EAS provides the S-EES with the target DNAI. The S-EAS also includes an EAS service continuity support indicator indicating that the S-EAS decided ACR according to clause 8.8.2.4 of TS 23.558 is to be used for the ACR. The request may include prediction expiration time.
NOTE 1: The trigger condition to invoke the Discover T-EAS API is up to application service logic, which is out of scope of this specification.

If the request is received from the S-EAS at step 8-1a, then at step 8-2 the S-EES checks whether the requesting EAS is authorized to perform the discovery operation. If the UE location is not known to the S-EES or provided by the S-EAS request, then the S-EES may interact with 3GPP core network to retrieve the UE location. If the S-EES decided to execute the ACR at step 8-1b or when the requesting EAS is authorized, the S-EES checks if there exists a T-EAS information (registered or cached) that can satisfy the requesting EAS information, additional query filters and the Expected AC Service KPIs and the Minimum required AC Service KPIs if received from the EEC during the EAS discovery or from the S-EAS in step 8-1a. If the S-EES finds the T-EAS(s) in the cached or registered information, the flow either continues with step 8-5 for the S-EAS triggered discovery or stops for the S-EES decided ACR execution. Otherwise, at step 8-2 the S-EES retrieves the T-EES address from the ECS as specified in clause 8.8.3.3 of TS 23.558 and continues with step 8-3.

At step 8-3, the S-EES invokes the EAS discovery request on the T-EES retrieved from the ECS. The EAS discovery request includes the requestor identifier [EESID] along with the security credentials and includes EAS discovery filter. In the EAS discovery filter, the S-EES may include prediction expiration time, the Expected AC Service KPIs and the Minimum required AC Service KPIs if received from the EEC during the EAS discovery or from the S-EAS in step 8-1a.

The S-EES also includes the EEC service continuity support indicator received from the EEC during EAS discovery. If in step 8-1a the S-EES received an EAS service continuity support indicator from the S-EAS, then the S-EES includes this EAS service continuity support indicator and its own EES service continuity support indicator indicating the ACR scenarios supported by the EES. If in step 8-1b the S-EES decided to execute the ACR, the S-EES includes the EAS service continuity support indicator received from the S-EAS during EAS registration and includes an EES service continuity support indicator indicating that the S-EES executed ACR according to clause 8.8.2.5 of TS 23.558 is to be used for the ACR.

Upon receiving the request, the T-EES may trigger the EAS management system to instantiate the T-EAS that matches with EAS discovery filter IEs (e.g. ACID) as in clause 8.12 of TS 23.558.

At step 8-4, the T-EES discovers the T-EAS(s) and responds with the discovered T-EAS information to the S-EES. To filter T-EAS(s), the T-EES utilizes the discovery filters (e.g. Expected AC Service KPIs and the Minimum required AC Service KPIs) and the indications which ACR scenarios are supported by the AC, the EEC, the S-EES and the S-EAS. If T-EES gets the Expected AC service KPIs or the Minimum required AC Service KPIs, the T-EES may collect Edge load performances from ADAES or OAM to find T-EAS(s) that satisfies the Expected AC service KPIs or the Minimum required AC Service KPIs. The S-EES may cache the T-EAS information.
NOTE 2: The Edge load performance can be either statistics or prediction. Editor's Note: The EES uses local policies to determine the use of statistics or prediction for evaluating KPIs. It is FFS whether the EES may also use request information to make this determination.

At step 8-5, if the request was received from the S-EAS at step 8-1a, the S-EES responds to the S-EAS with the discovered T-EAS Information.

### FURTHER DETAILS

Further details are provided. It is to be understood that these details are very specific for exemplary purposes only.

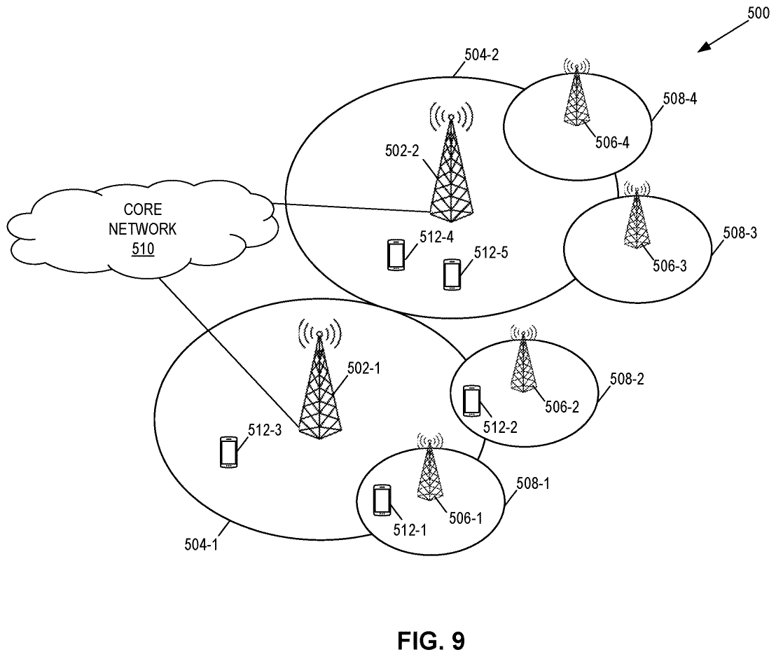

FIG. 9 illustrates one example of a cellular communications system 500 in which embodiments of the present disclosure may be implemented. In the embodiments described herein, the cellular communications system 500 is a 5GS (5G system) including a NG-RAN (Next Generation RAN) and a 5GC (5G Core). In this example, the RAN includes base stations 102-1 and 502-2, which in the 5GS include NR base stations (gNBs) and optionally next generation eNBs (ng-eNBs) (e.g., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or RRHs (Remote Radio Heads), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5G System (5GS) is referred to as the 5GC. The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs, but the present disclosure is not limited thereto.

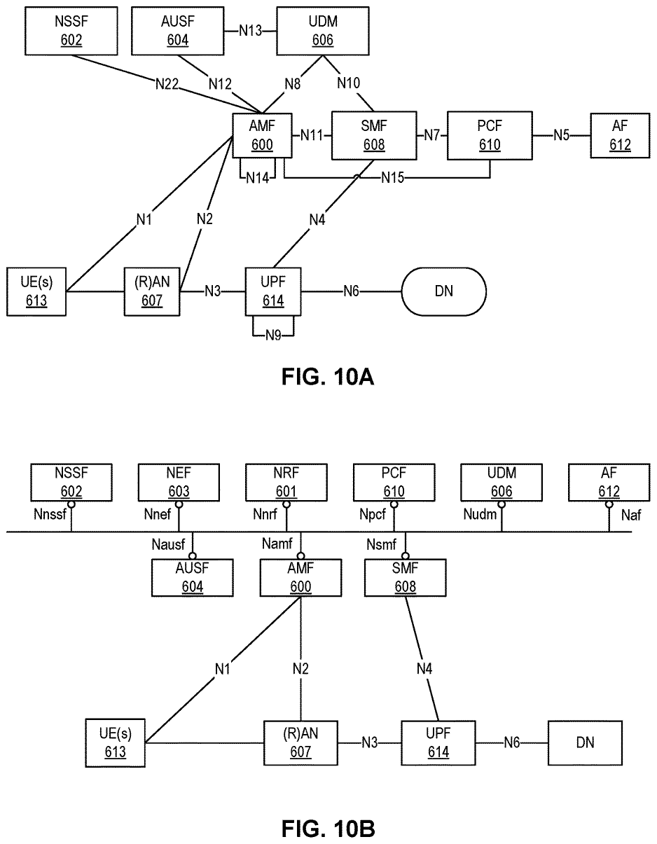

Referring now to FIG. 10A, shown is a block diagram of a wireless communication system represented as a 5G network architecture composed of core NFs (Network Functions), where interaction between any two NFs is represented by a point-to-point reference point/interface. FIG. 10A can be viewed as one particular implementation of the system 500 of FIG. 9.

Seen from the access side the 5G network architecture shown in FIG. 10A includes a plurality of UEs 613 connected to either a RAN 607 or an (Access Network) as well as an AMF 600. Typically, the R (AN) 607 comprises base stations, e.g. such as eNBs or gNBs or similar. Seen from the core network side, the 5GC NFs shown in FIG. 10A include a NSSF 602, an AUSF 604, a UDM 606, the AMF 600, a SMF 608, a PCF 610, and an AF (Application Function) 612.

Reference point representations of the 5G network architecture are used to develop detailed call flows in the normative standardization. The N1 reference point is defined to carry signaling between the UE 613 and AMF 600. The reference points for connecting between the AN 607 and AMF 600 and between the AN 607 and UPF 614 are defined as N2 and N3, respectively. There is a reference point, N11, between the AMF 600 and SMF 608, which implies that the SMF 608 is at least partly controlled by the AMF 600. N4 is used by the SMF 608 and UPF 614 so that the UPF 614 can be set using the control signal generated by the SMF 608, and the UPF 614 can report its state to the SMF 608. N9 is the reference point for the connection between different UPFs 614, and N14 is the reference point connecting between different AMFs 600, respectively. N15 and N7 are defined since the PCF 610 applies policy to the AMF 600 and SMF 608, respectively. N12 is utilized for the AMF 600 to perform authentication of the UE 613. N8 and N10 are defined because the subscription data of the UE 613 is utilized for the AMF 600 and SMF 608.

The 5GC network aims at separating UP and CP. The UP carries user traffic while the CP carries signaling in the network. In FIG. 10A, the UPF 614 is in the UP and all other NFs, i.e., the AMF 600, SMF 608, PCF 610, AF 612, NSSF 602, AUSF 604, and UDM 606, are in the CP. Separating the UP and CP guarantees each plane resource to be scaled independently. It also allows UPFs to be deployed separately from CP functions in a distributed fashion. In this architecture, UPFs may be deployed very close to UEs to shorten the RTT (Round Trip Time) between UEs and data network for some applications involving low latency.

The core 5G network architecture is composed of modularized functions. For example, the AMF 600 and SMF 608 are independent functions in the CP. Separated AMF 600 and SMF 608 allow independent evolution and scaling. Other CP functions like the PCF 610 and AUSF 604 can be separated as shown in FIG. 10A. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

Referring now to FIG. 10B, shown is a block diagram of a 5G network architecture using service-based interfaces between the NFs in the CP, instead of the point-to-point reference points/interfaces used in the 5G network architecture of FIG. 10A. However, the NFs described above with reference to FIG. 10B correspond to the NFs shown in FIG. 10A. The service(s) etc. that a NF provides to other authorized NFs can be exposed to the authorized NFs through the service-based interface. In FIG. 10B, the service based interfaces are indicated by the letter “N” followed by the name of the NF, e.g. Namf for the service based interface of the AMF 600 and Nsmf for the service based interface of the SMF 608, etc. The NEF 603 and the NRF 601 in FIG. 10B are not shown in FIG. 10A discussed above. However, it should be clarified that all NFs depicted in FIG. 10A can interact with the NEF 603 and the NRF 601 of FIG. 10B as necessary, though not explicitly indicated in FIG. 10A.

Some properties of the NFs shown in FIGS. 10A and 10B may be described in the following manner. The AMF 600 provides UE-based authentication, authorization, mobility management, etc. A UE 613 even using multiple access technologies is basically connected to a single AMF 600 because the AMF 600 is independent of the access technologies. The SMF 608 is responsible for session management and allocates IP (Internet Protocol) addresses to UEs. It also selects and controls the UPF 614 for data transfer. If a UE 613 has multiple sessions, different SMFs 608 may be allocated to each session to manage them individually and possibly provide different functionalities per session. The AF 612 provides information on the packet flow to the PCF 610 responsible for policy control in order to support QoS. Based on the information, the PCF 610 determines policies about mobility and session management to make the AMF 600 and SMF 608 operate properly. The AUSF 604 supports authentication function for UEs or similar and thus stores data for authentication of UEs or similar while the UDM 606 stores subscription data of the UE 613. The DN (Data Network), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

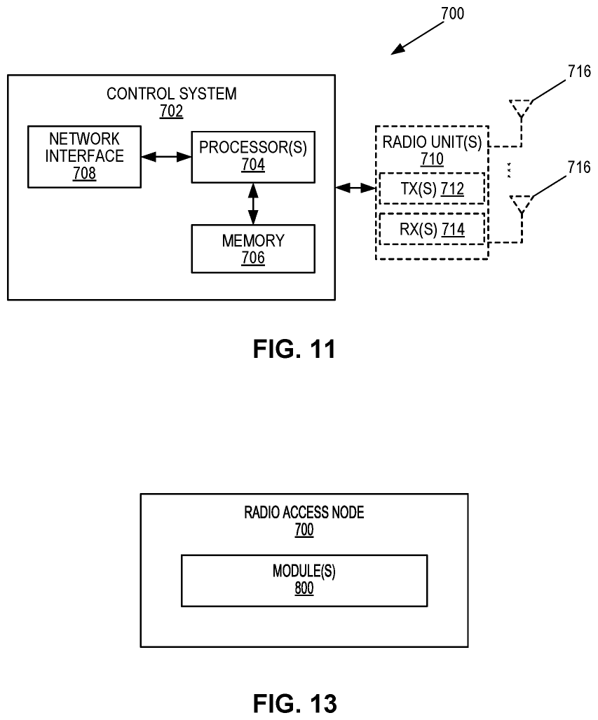

FIG. 11 is a schematic block diagram of a radio access node 700 according to some embodiments of the present disclosure. Optional features are represented by dashed boxes. The radio access node 700 may be, for example, a base station 102 or 106 or a network node that implements all or part of the functionality of the base station 102 or gNB described herein. As illustrated, the radio access node 700 includes a control system 702 that includes one or more processors 704 (e.g., CPUs (Central Processing Units), ASICs (Application Specific Integrated Circuits), FPGAs (Field Programmable Gate Arrays), and/or the like), memory 706, and a network interface 708. The one or more processors 704 are also referred to herein as processing circuitry. In addition, the radio access node 700 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of a radio access node 700 as described herein. In some embodiments, the function(s) are implemented in software that is stored, e.g., in the memory 706 and executed by the one or more processors 704.

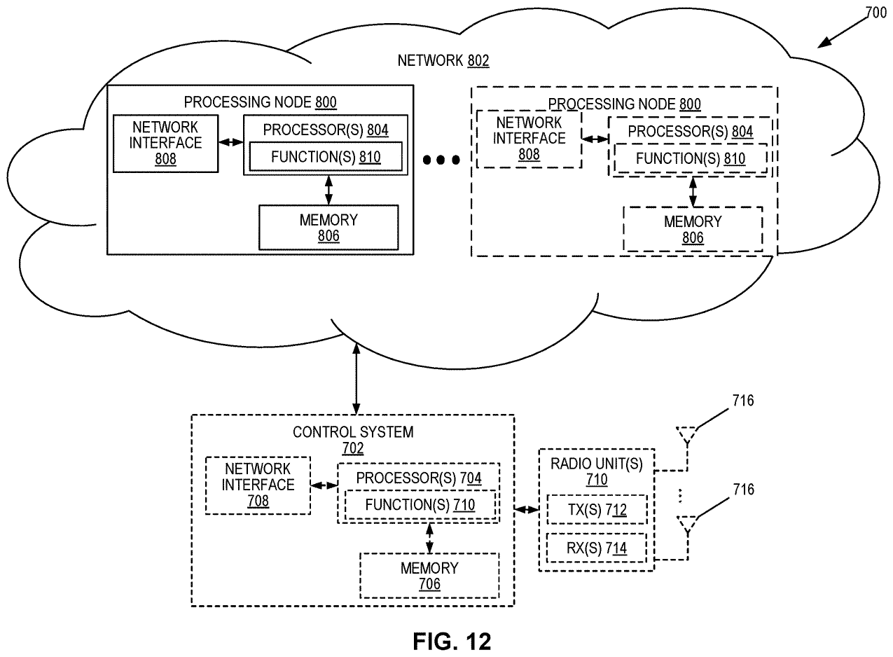

FIG. 12 is a schematic block diagram that illustrates a virtualized embodiment of the radio access node 700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 700 in which at least a portion of the functionality of the radio access node 700 is implemented as a virtual component(s) (e.g., via a virtual machine(s) executing on a physical processing node(s) in a network(s)). As illustrated, in this example, the radio access node 700 may include the control system 702 and/or the one or more radio units 710, as described above. The control system 702 may be connected to the radio unit(s) 710 via, for example, an optical cable or the like. The radio access node 700 includes one or more processing nodes 800 coupled to or included as part of a network(s) 802. If present, the control system 702 or the radio unit(s) 710 are connected to the processing node(s) 800 via the network 802. Each processing node 800 includes one or more processors 804 (e.g., CPUs, ASICs, FPGAs, and/or the like), memory 806, and a network interface 808.

In this example, functions 810 of the radio access node 700 described herein are implemented at the one or more processing nodes 800 or distributed across the one or more processing nodes 800 and the control system 802 and/or the radio unit(s) 810 in any desired manner. In some particular embodiments, some or all of the functions 810 of the radio access node 700 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 802 is used in order to carry out at least some of the desired functions 810. Notably, in some embodiments, the control system 802 may not be included, in which case the radio unit(s) 810 communicates directly with the processing node(s) 800 via an appropriate network interface(s).

In some embodiments, a computer program including instructions which, when executed by at least one processor, causes the at least one processor to carry out the functionality of radio access node 700 or a node (e.g., a processing node 800) implementing one or more of the functions 810 of the radio access node 700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the radio access node 700 according to some other embodiments of the present disclosure. The radio access node 700 includes one or more modules 800, each of which is implemented in software. The module(s) 800 provide the functionality of the radio access node 700 described herein. This discussion is equally applicable to the processing node 700 of FIG. 12 where the modules 800 may be implemented at one of the processing nodes 700 or distributed across multiple processing nodes 700 and/or distributed across the processing node(s) 700 and the control system 702.

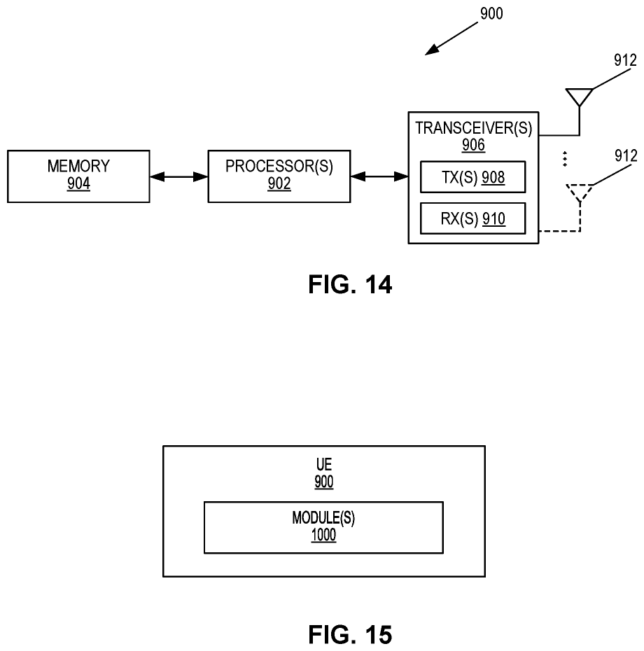

FIG. 14 is a schematic block diagram of a wireless communication device 900 according to some embodiments of the present disclosure. As illustrated, the wireless communication device 900 includes one or more processors 902 (e.g., CPUs, ASICS, FPGAs, and/or the like), memory 904, and one or more transceivers 906 each including one or more transmitters 908 and one or more receivers 910 coupled to one or more antennas 912. The transceiver(s) 906 includes radio-front end circuitry connected to the antenna(s) 912 that is configured to condition signals communicated between the antenna(s) 912 and the processor(s) 902, as will be appreciated by on of ordinary skill in the art. The processors 902 are also referred to herein as processing circuitry. The transceivers 906 are also referred to herein as radio circuitry. In some embodiments, the functionality of the wireless communication device 900 described above may be fully or partially implemented in software that is, e.g., stored in the memory 904 and executed by the processor(s) 902. Note that the wireless communication device 900 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 900 and/or allowing output of information from the wireless communication device 900), a power supply (e.g., a battery and associated power circuitry), etc.

In some embodiments, a computer program including instructions which, when executed by at least one processor, causes the at least one processor to carry out the functionality of the wireless communication device 900 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 900 according to some other embodiments of the present disclosure. The wireless communication device 900 includes one or more modules 1000, each of which is implemented in software. The module(s) 1000 provide the functionality of the wireless communication device 900 described herein.

Each station 1106A, 1106B, 1106C is connectable to the core network 1104 over a wired or wireless connection 1110. A first UE 1112 located in coverage area 1108C is configured to wirelessly connect to, or be paged by, the corresponding base station 1106C. A second UE 1114 in coverage area 1108A is wirelessly connectable to the corresponding base station 1106A. While a plurality of UEs 1112, 1114 are illustrated in this example, the disclosed embodiments are equally applicable to a situation where a sole UE is in the coverage area or where a sole UE is connecting to the corresponding base station 1106.

The telecommunication network 1100 is itself connected to a host computer 1116, which may be embodied in the hardware and/or software of a standalone server, a cloud-implemented server, a distributed server, or as processing resources in a server farm. The host computer 1116 may be under the ownership or control of a service provider, or may be operated by the service provider or on behalf of the service provider. Connections 1118 and 1120 between the telecommunication network 1100 and the host computer 1116 may extend directly from the core network 1104 to the host computer 1116 or may go via an optional intermediate network 1122. The intermediate network 1122 may be one of, or a combination of more than one of, a public, private, or hosted network; the intermediate network 1122, if any, may be a backbone network or the Internet; in particular, the intermediate network 1122 may comprise two or more sub-networks (not shown).

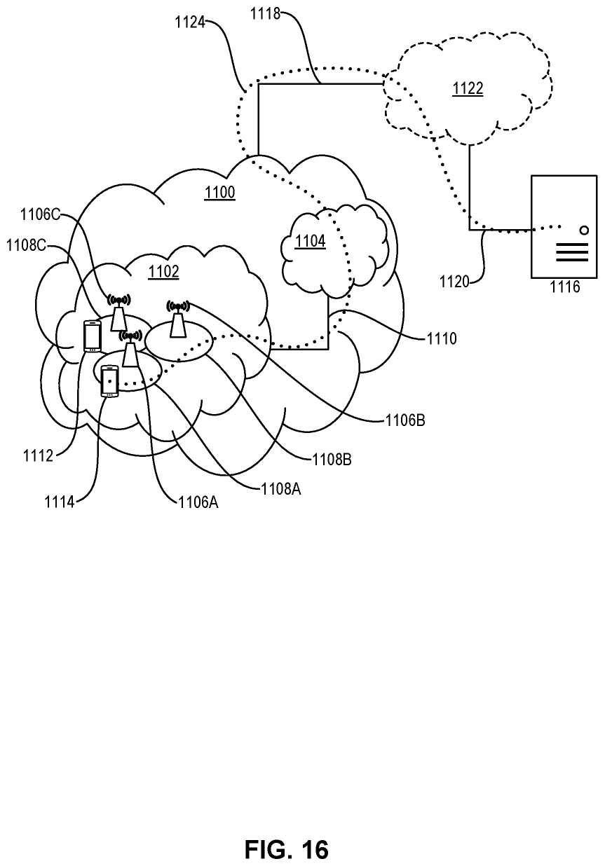

The communication system of FIG. 16 as a whole enables connectivity between the connected UEs 1112, 1114 and the host computer 1116. The connectivity may be described as an OTT (Over-the-Top) connection 1124. The host computer 1116 and the connected UEs 1112, 1114 are configured to communicate data and/or signaling via the OTT connection 1124, using the access network 1102, the core network 1104, any intermediate network 1122, and possible further infrastructure (not shown) as intermediaries. The OTT connection 1124 may be transparent in the sense that the participating communication devices through which the OTT connection 1124 passes are unaware of routing of uplink and downlink communications. For example, the base station 1106 may not or need not be informed about the past routing of an incoming downlink communication with data originating from the host computer 1116 to be forwarded (e.g., handed over) to a connected UE 1112. Similarly, the base station 1106 need not be aware of the future routing of an outgoing uplink communication originating from the UE 1112 towards the host computer 1116.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs (Digital Signal Processor), special-purpose digital logic, and the like. The processing circuitry may be configured to execute program code stored in memory, which may include one or several types of memory such as ROM (Read Only Memory), RAM (Random Access Memory), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Numerous modifications and variations of the present disclosure are possible in light of the above teachings. It is therefore to be understood that within the scope of the appended claims, the disclosure may be practised otherwise than as specifically described herein.

1. A method for execution by an EES (Edge Enabler Server) of an EDN (Edge Data Network), comprising:
during a service continuity procedure involving an AC (Application Client) of a UE (User Equipment), receiving a first message indicating a prediction expiration time, wherein the prediction expiration time is an estimated time that the UE may reach a predicted/expected UE location or an EAS (Edge Application Server) service area at latest;
determining at least one candidate EAS for the AC of the UE based on at least the prediction expiration time; and
sending a second message based on the at least one candidate EAS that has been determined.

2. The method of claim 1, wherein the first message is an EAS discovery request, an EAS discovery subscription request, or an EAS discovery update request.

3. The method of claim 1, wherein the first message is received from an EEC (Edge Enabler Client) of the UE, a source EAS, or a source EES.

4. The method of claim 1, wherein the second message is an EAS discovery notification or an EAS discovery response.

5. The method of claim 1, wherein the second message indicates the at least one candidate EAS.

6. The method of claim 1, wherein the second message is sent before expiration of the prediction expiration time.

7. The method of claim 1, wherein the second message comprises prediction information that indicates a prediction confidence level for EAS service status change and prediction validity time for such EAS service status change.

8. The method of claim 1, further comprising:
receiving edge load analytics from ADAES (Application Data Analytics Enablement Service) and/or performance data from OAM (Operations, Administration and Maintenance), and confirming whether the at least one candidate EAS satisfies an expected AC service KPIs or minimum required AC service KPIs.

9. The method of claim 1, further comprising:
receiving prediction request and/or local policy, and using received EAS endpoints from EEC or all registered EAS endpoints in consuming ADAES (Application Data Analytics Enablement Service) to monitor EAS service status.

10. A non-transitory CRM (Computer Readable Medium) having recorded thereon statements and instructions that, when executed by a processor of an EES (Edge Enabler Server) of an EDN (Edge Data Network), configure the processor to implement a method according to claim 1.

11. An EES (Edge Enabler Server) of an EDN (Edge Data Network), comprising:
a network interface configured to communicate with other network nodes; and
candidate EAS (Edge Application Server) circuitry coupled to the network interface and configured to: during a service continuity procedure involving an AC (Application Client) of a UE (User Equipment), receive over the network interface a first message indicating a prediction expiration time, wherein the prediction expiration time is an estimated time that the UE may reach a predicted/expected UE location or an EAS (Edge Application Server) service area at latest; determine at least one candidate EAS for the AC of the UE based on at least the prediction expiration time; and send a second message over the network interface based on the at least one candidate EAS that has been determined.

12. The EES of claim 11, wherein the first message is an EAS discovery request, an EAS discovery subscription request, or an EAS discovery update request.

13. The EES of claim 11, wherein the first message is received from an EEC (Edge Enabler Client) of the UE, a source EAS, or a source EES.

14. The EES of claim 11, wherein the second message is an EAS discovery notification or an EAS discovery response.

15. The EES of claim 11, wherein the second message indicates the at least one candidate EAS.

16. The EES of claim 11, wherein the second message is sent before expiration of the prediction expiration time.

17. The EES of claim 11, wherein the second message comprises prediction information that indicates a prediction confidence level for EAS service status change and prediction validity time for such EAS service status change.

18. The EES of claim 11, wherein the candidate EAS circuitry is configured to receive edge load analytics from ADAES (Application Data Analytics Enablement Service) and/or performance data from OAM (Operations, Administration and Maintenance), and confirm whether the at least one candidate EAS satisfies an expected AC service KPIs or minimum required AC service KPIs.

19. The EES of claim 11, wherein the candidate EAS circuitry is configured to receive prediction request and/or local policy, and use received EAS endpoints from EEC or all registered EAS endpoints in consuming ADAES (Application Data Analytics Enablement Service) to monitor EAS service status.

20. A method for execution by an EES (Edge Enabler Server) of an EDN (Edge Data Network), comprising:
during a service continuity procedure involving an AC (Application Client) of a UE (User Equipment), determining at least one candidate EAS for the AC of the UE; and
sending a message based on the at least one candidate EAS that has been determined, wherein the message comprises prediction information that indicates a prediction confidence level for EAS service status change and prediction validity time for such EAS service status change.

21. The method of claim 20, wherein the at least one candidate EAS is determined based on an EEC prediction request and/or local policy.

22. A non-transitory CRM (Computer Readable Medium) having recorded thereon statements and instructions that, when executed by a processor of an EES (Edge Enabler Server) of an EDN (Edge Data Network), configure the processor to implement a method according to claim 20.

23. An EES (Edge Enabler Server) of an EDN (Edge Data Network), comprising:
a network interface configured to communicate with other network nodes; and
candidate EAS (Edge Application Server) circuitry coupled to the network interface and configured: during a service continuity procedure involving an AC (Application Client) of a UE (User Equipment), determine at least one candidate EAS for the AC of the UE; and send a message over the network interface based on the at least one candidate EAS that has been determined, wherein the message comprises prediction information that indicates a prediction confidence level for EAS service status change and prediction validity time for such EAS service status change.

24. The EES of claim 23, wherein the candidate EAS circuitry determines the at least one candidate EAS based on an EEC prediction request and/or local policy.
